(19) United States
(12) Patent Application Publication
(10) Pub. No.: US 2003/0188323 A1
(43) Pub. Date: Oct. 2, 2003

(54) Portable communication device with a display and control block

(76) Inventor: Christoph Wittlinger, Zurich (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/387,451

(22) Filed: Mar. 14, 2003

(30) Foreign Application Priority Data
Mar. 30, 2002 (EP) EP 02 007 448.0

(51) Int. Cl. H04N 7/16

(52) U.S. Cl. 725/153

(57) ABSTRACT

The invention is based on the task to indicate a mobile communication device, with which a multiple number of different operational modes and functions can be carried out and which can still be operated with only a few operating controls in an almost self-explanatory way. A portable communication device is provided with a display and a control block according to the invention, where operational modes, different and presettable by a user and/or based on the switching preset and self-adjusting are provided, whereby a specific allocation of the control block is defined for each operational mode and, according to the current operational mode, the appurtenant allocation of the control block is activated and an otherwise keyless control and navigation through the different operational modes of the device is provided. It enables the user of the communication device this way to control the functions and operational modes of the device by only some few operational controls of the control block and to thereby, mostly self-explanatory, have always access to—as much as the functionality of the current operational mode permits it—the same operational controls of the control block despite different operational modes. A design which is particularly appropriate for a user-friendly and easy operation, envisions that the control block comprises a swash-plate and a number of keys surrounding this swash-plate satellite-like.

### BACKGROUND OF THE INVENTION

The present invention relates to a portable communication device with a display and a control block. Such a portable communication devices are known from European patent application EP 0 737 908 A1. The disclosed portable information device can be coupled via wire or wirelessly to any kind of data processing system. It is then possible with this device to view status data of the data processing system and to analyze and correct existing errors in this data processing system by remote control. Disadvantages of the disclosed device include that it is only applicable to a few specially configured data processing systems.

A disclosed information device in U.S. Pat. No. 5,812,930 avoids the above disadvantage because the central thought of this device's invention is to possess at least one unidirectional broadband and at least one bi-directional narrowband transmission line. It is thereby a mandatory feature of the disclosed invention here that the information device decides on its own, in dependence from the information to be transmitted and/or to be received, which of the available transmission lines carries out the data transfer. It is therefore possible, by using the standardized transmission protocols, as for example TCP/IP, to couple the information device to different external devices which are connected to a corresponding network. This information device permits the presentation of TV programs and of a video or DVD cassette as well, available in an external system, which data can be supplied only by the broadband transmission line according to regulations.

With increasing variety of functions and operators' program on such mobile communication devices, the requirements are constantly increasing, such that communication devices can be operated by the user easily and almost self-explanatory. At a mobile telephone, for example, an alphanumerical key block and different menu keys are provided, which allocation can vary according to each selected menu point. The functions corresponding to the allocation, which can be activated by the menu keys, are thereby displayed in the display of the mobile telephone more or less self-explanatory by meaningful symbols.

This procedure is, based on the limited functionality, just barely appropriate for a mobile telephone, in order to operate the device without any greater expense, i.e. without a generally undesired recourse to the operator's manual. For complex devices, as for example a personal digital assistant (PDA) or a web pad or a tablet PC, there are currently no appropriate solutions, in order to use the devices self-explanatory with a low number of input and operational controls.

### SUMMARY OF THE INVENTION

The present invention is based on the task of indicating a mobile communication device with which a multiple number of different kinds of operations and functions are practicable and which can still be operated with only a few operational controls in an almost self-explanatory way.

This task is solved according to the present invention in that a portable communication device with a display and a control block is provided where different operational modes, presettable by the user and/or preset self-regulating based on the circuit, are provided, whereby a specific allocation of the control block is defined for each operational mode and the associated allocation of the control block according to the current operational mode is activated and an otherwise key-less control and navigation is provided by the different operational modes of the device.

This way the communication device enables the user to control the functions and operational modes of the device according to only some few operational controls of the control block and to have access mostly self-explanatory to always—as long as the functionality of the current operational mode permits it—the same operational controls of the control block despite different operational modes.

An embodiment of the invention which is particularly appropriate for a user-friendly and simple operation provides that the control block includes a swash plate and a number of keys which surround this swash plate satellite-like. A single-handed control of the communication device is even obtained this way, which particularly offers the navigation by the swash plate in a self-explanatory way and permits comparably fixed, for the different operational modes recurrent functions by an appropriate allocation of the keys surrounding the swash plate.

For the easy handleability of the communication device in particular and for the suitability as means for wireless internet access, it is particularly useful, if the display is designed rectangular and surrounded by a frame, where the control block is integrated. By using the communication device at the control block, the presentation on the display is thereby not impaired and the communication device can, at the same time, be held at the frame during operation. This characteristic is converted particularly well thereby, if the control block, referring to the display, placed in a horizontal position at the right, upper section of the frame, is placed preferably at an ergonomically designed buckling of the frame. Accordingly, an arrangement at the left, upper section of the frame can be provided for left-handers. A kind of lever is obtained by the buckling, by which the device rests in the palm when held and can be operated by the thumb.

Alternatively, it is of course possible to design the display rectangular and operable over the surface and to realize the control block shown virtually on the display. Such a design could be particularly offered for the usage in difficult environments (wetness, humidity, dust), when the inner life of the communication device has to be hermetically sealed from the environment. A heat exchange could be realized at such a design by a heat exchange surface arranged in an airflow. To guarantee a one-handed operation here as well, a preset arrangement of the control block depending from the operation mode could be provided, and that is preferably the right side down referring to the display in horizontal position. In a horizontal position means in this context that the communication device is turned towards the user in such a way that the rectangular display faces the user in an oblong format. Accordingly, the presentation in upright format means an upright display.

The user-friendliness and clearness of the operation is further stimulated, if the swash-plate is surrounded of four, referring to the center of the swash-plate, equidistantly placed key elements. The usability consequent to at least two different allocations of the respective orientation of the device is thereby obtained particularly well, if the key elements are arranged in the directions NW, NE, SE and SW, i.e. thus each placed on the diagonals in horizontal position. But this characteristic is basically always already obtained, if the arrangement of the key elements is essentially provided symmetrical to the swash-plate.

For the operation of the communication device in different orientations, it is particularly advantageous if the allocation of the swash-plate and the key elements follow the orientation of the display. Certain operational modes, as for example e-book-mode can make it necessary that the communication device is used more likely with an upright display (an entire book page is disclosed). In order to not unnecessarily complicate the tracking of the allocation of the swash-plate and the key elements, a mean for the detection of the orientation of the display and an allocation each—according to the detected orientation—in case of an upright display and in case of a display in horizontal position, can be provided. The orientation of the device is therefore observed in the device and switched from one to the other allocation with the exceeding of a limiting value for the swing angle.

To further contribute to an increase of the operational comfort, the swash-plate and the key elements are allocated to means which detect an intensity of the operating pressure and/or duration of application and arrange adequate modifications of a function to be controlled according to the allocation. This way, the speeds at for example a function “zoom-in” or “zoom-out” can be modified and support the user's endeavor for an acceleration of a zoom-operation.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts an aspect on a mobile communication device with a control block in schematic disclosure;

FIG. 2 depicts an enlarged section from a mobile communication device according to FIG. 1 in the area of the control block in schematic disclosure; and

FIG. 3 depicts an aspect on the mobile communication device held by a user according to FIG. 1 in schematic disclosure.

### DETAILED DESCRIPTION OF THE INVENTION

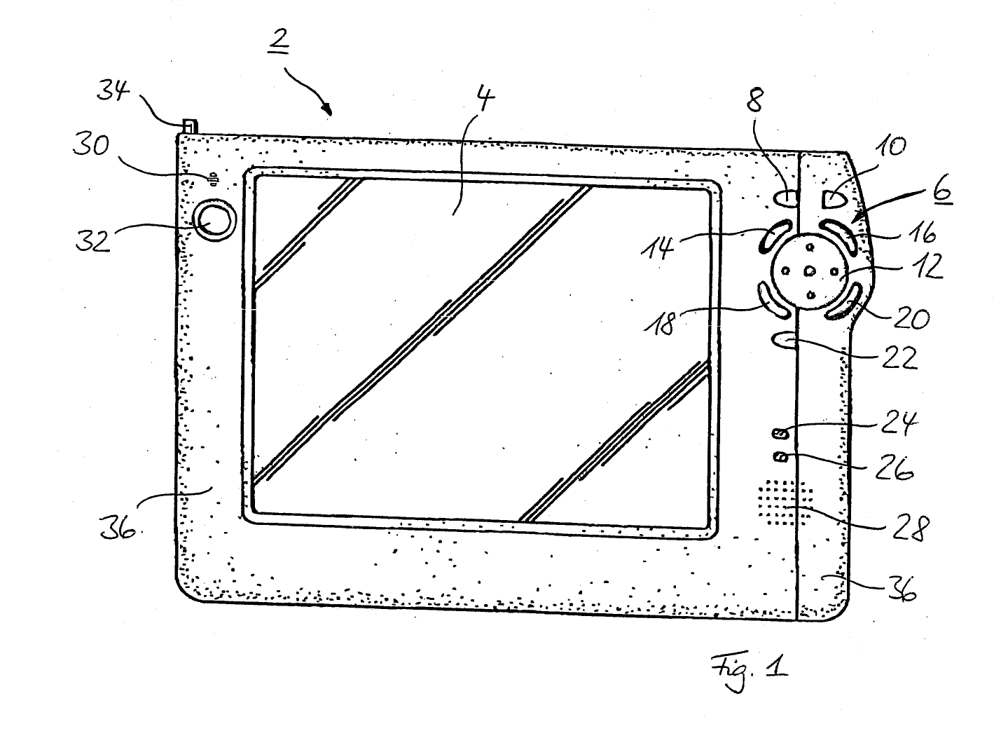

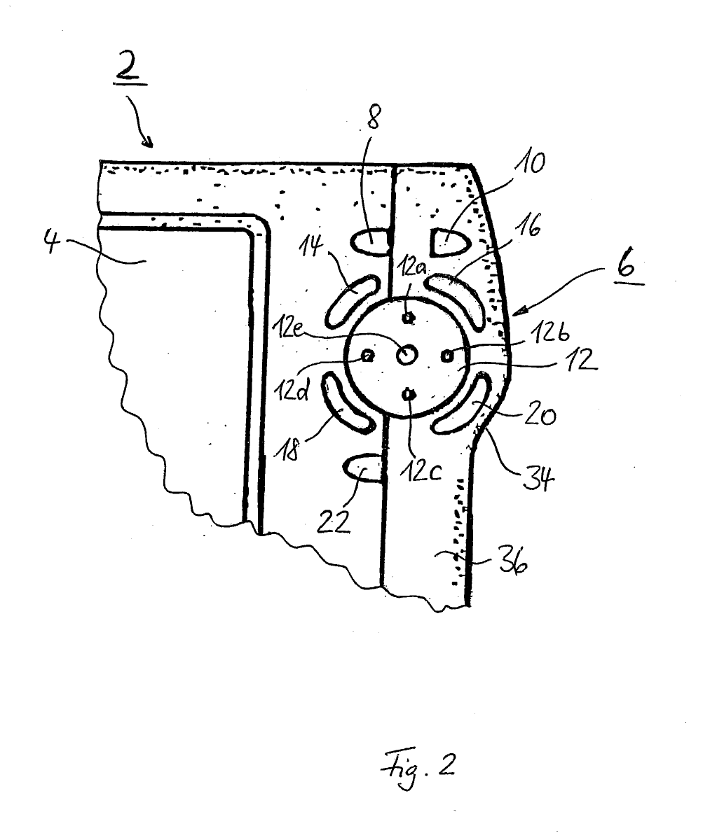

FIG. 1 depicts an aspect of a mobile communication device in schematic disclosure, which is described in the following as thin-client 2. The shown disclosure is essentially dominated by an LCD display 4 operable over the surface and orientated in horizontal position and provides for recognition of a few operational and/or display elements which are described summarily as control block 6. The control block 6 thereby comprises, apart from an on/off switch 8 and a key 10 for the software-control which corresponds to the right mouse key under the operational system windows CE, a swash-plate 12 as an essential operational control, around which four satellite-like arranged push buttons 14 to 20 are symmetrically placed. The swash-plate 12 shows four action points to the top left, right and down (12a to 12d; see FIG. 2). A central action point 12e is additionally provided.

A keyboard on/off key 22 is placed in a horizontal position below the swash-plate 12 with its push buttons 14 to 20 arranged satellite-like with which a keyboard display can be show and/or hidden. Two light emitting diodes 24, 26 show the charging function of an energy storage and in particular the operating status of the mobile thin-client 2. A loudspeaker 28 and a microphone 30 are provided for audio purposes, i.e. general purpose communication. Below the microphone 30, a camera 32 is additionally placed, which is here realized according to CCD techniques. This camera 32 permits the transmission of pictures recorded with in for example a communicator mode. A very comfortable picturephone can be realized this way with the thin-client 2 within the scope of this operational mode.

With the pressing of the on/off switch 8, the thin-client is 2 is switched on and a start menu, which shows here ten elliptical-like, but not further disclosed here, pushing surfaces, is shown on the LCD touch screen 4 operable over the surface. Different operational modes of the mobile thin-client 2 can be activated by these pushing surfaces and by tipping on the respective buttons. But in principle, a co-started program can examine the circuit of the mobile thin-client 2 and switch it to a mode according to the circuit, but which can be still modified subsequently by the user by the start menu as described above.

All the current applications are terminated with one of the pushing surfaces; another pushing surface invokes the help function. Additional pushing surfaces start a setup mode, a so-called ink writer mode (electronic notebook, with which can be written and drawn), an office mode (word processing, table calculation, display presentation and database application, for example Microsoft pocket-office) and a personal assistant mode (tasks, calendar, contacts and incoming mail, for example Microsoft Outlook). This mode corresponds thereby to the PDC functionality already mentioned above. An internet connection is produced with one additional pushing surface, a web browser started and a preset homepage is loaded. The mobile thin client 2 is activated by one of the pushing surfaces as well as a mobile telephone in a communicator mode and operated by yet another pushing surface in a video/TV mode. An insertable pen 34 into the side of the case is used to activate the pushing surfaces, apart from the tipping with the finger tip.

In order for the thin client 2 to remain operable easily and self-explanatory, given these many different operational modes, fixed preset allocations of the combined operational controls in the key block 6 are provided, which can be activated according to the current operational mode.

A number of allocations are thereby explained in the following as examples for the different operational modes:

Normal basic mode:

TABLE 1
Allocation of the control block in the basic mode

| | LCD display in horizontal | LCD display in vertical |
|---|---|---|
| Key | position | position |
| 12a | Navigation upwards | Navigation to the right |
| 12b | Navigation to the right | Navigation downwards |
| 12c | Navigation downwards | Navigation to the left |
| 12d | Navigation to the left | Navigation upwards |
| 12e 1x | Mode indication and selection | Mode indication and selection |
| 12e 1x | Turn the allocation by 90° | Turn the allocation by 90° |
| 14 | Voice/push to talk (ptt) | Menu key |
| 16 | Menu key | Enter |
| 18 | Escape | Voice/push to talk (ptt) |
| 20 | Enter | escape |

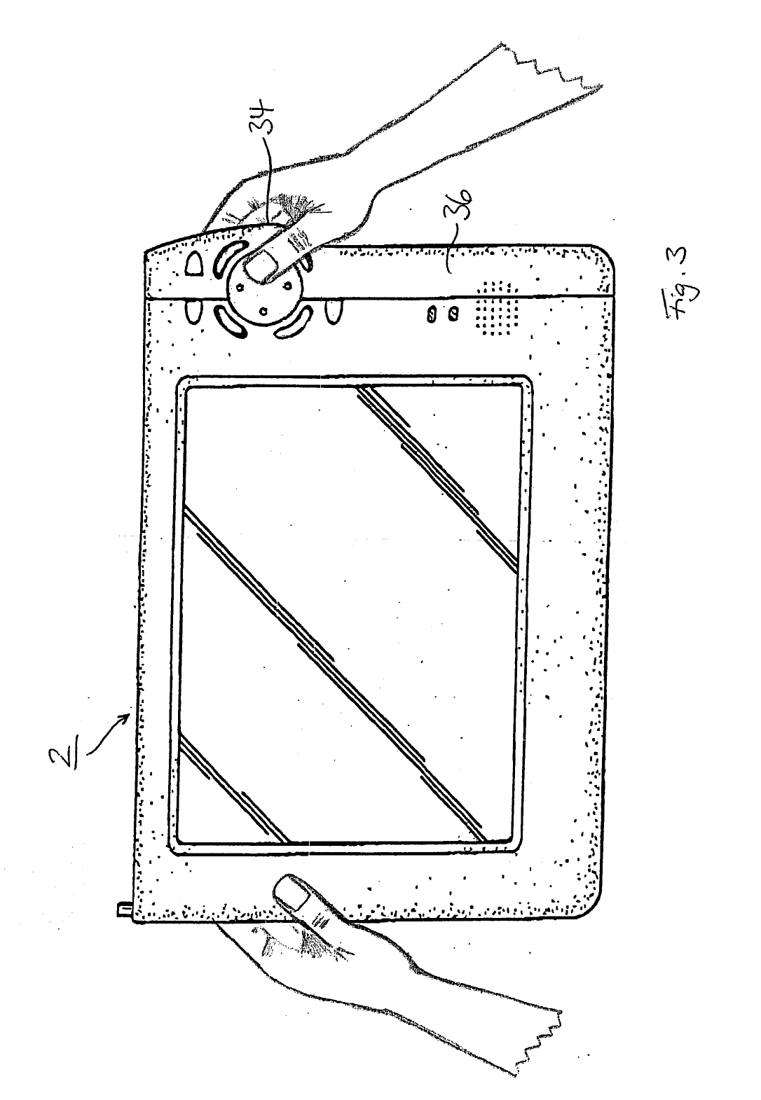

In the first column of table 1, the different keys are indicated according to the second column with functionalities for the display in horizontal position 4, and according to the third column, with the functionalities indicated from the display in vertical position 4. When the user now holds the thin client 2 in his or her hands, as is disclosed in FIG. 3, on the one hand an ergonomically designed buckling 34 permits the comfortable carrying of the thin client 2 and on the other hand the single-handed operation, for which essentially only the thumb of the right hand is used. The thin client 2 can thereby be used with a display 4 in horizontal or vertical position according to the set mode and the allocation of the control block can be adjusted to the orientation accordingly, by pressing the action point 12e twice (comparable with a double mouse click). In addition to the allocation indicated in table 1, the action points 12a to 12d are additionally suitable also for scrolling of the content menu, when the menu was invoked.

A standing display 4 might be found more likely in an e-book mode for example, where books and other print media, for example the daily newspaper, are presented in electronic form. The allocation of the control block 6 for this mode looks as follows:

12a to 12d: Navigation and context-menu scroll as above;

18 and 14: Push to talk resp. context-menu as above;

20: Zoom in plus menu: escape

16: Zoom out plus menu: enter

12e 1x: Mode menu

12e 1x: Turn allocation by 90° as above.

A meaningful allocation of the control block 6 for the internet mode, i.e. for the browsing of the internet, can show the following distribution (display in horizontal position):

12a to 12d: Navigation and favorites-navigation;

14: Push to talk;

16: Show list of favorites;

18: Browse back to the last page

20: Browse forward to the next page

12e 1x: Mode menu

12e 1x: Turn allocation by 90° as above.

Additionally, keys 18 and 20 can here be superimposed with corresponding menu functions, if the mode menu was invoked with a single pressing of the action point 12e. Such menu functions can be “escape favorite” and “enter favorite” for the keys 18 to/and/or 20.

A next possible mode could be a movie/TV mode, where the thin client 2 is used for the reproduction of films and TV programs. The allocation of the control block 6 is then formed in the following way:

12a: Loudspeakers 28/headphones louder

12b: Program forward

12c: Loudspeakers 28/headphones softer

12d: Program backwards

16 and 12a to 12d: Scroll context-menu

14: Push to talk;

16: Menu

18: Escape

20: Enter

12e 1x: Mode Menu

12e 2x: Turn allocation by 90° as above.

The so-called communicator mode can be an additional mode, where the thin client 2 is used as mobile telephone/picturephone. The allocation then has the following distribution:

12a: Loudspeakers 28/headphones louder

12b: Camera zoom out

12c: Loudspeakers 28/headphones softer

12d: Camera zoom in

16 and 12a to 12d: Scroll context menu

14: Push to talk, i.e. receive and disconnect

16: Menu

18: Escape

20: Enter

12e 1x: Mode menu

12e 2x: Turn the allocation by 90° as above.

The allocation of the control block 6 can have the following form in game mode:

12a to 12d: Navigation through the game

16 and 12a to 12d: Scroll context menu

14: up

16: down

18: jump

20: shoot

12e 1x: mode menu

12e 2x: turn allocation by 90° as above.

In a possible video conference mode, the thin client 2 can be used for the control of an external video camera and for the reproduction of the picture on its LCD display 4 with the following allocation:

12a to 12d: Navigation picture detail

16 and 12a to 12d: Navigation through the context menu

14: Push to talk, receive and disconnect

16: Menu

18: Zoom-in plus menu escape

20: Zoom-out plus menu enter

12e 1x: mode menu

12e 2x: Turn allocation by 90° as above.

And a directly evocable mode for the changing of the setting of the device could of course be possible with the following allocation:

12a: Loudspeakers 28/headphones louder

12b: Picture lighter

12c: Loudspeakers 28/headphones softer

12d: Picture darker

16 and 12a to 12d: Scroll context-menu

14: Push to talk

16: Context menu

18: Escape

20: Enter

12e 1x: Mode-menu

12 2x: Turn allocation by 90° as above.

It therefore can be summarized that a number of keys and/or action points receive completely new functional allocations at a changing from one operational mode to another operational mode. On the other hand, other keys and/or action points show relatively constant certain recurrent functions in all operational modes. Key 16 may invoke the context menu, and generally lead to a temporary superposition of the primary operational mode related allocation, as for example menu enter and menu escape for the keys 20 to/and/or 18 and the navigation/scroll possibility for the action points 12a to 12d. The individual action points and keys can also supplementary be designed two-staged, so that different speeds result for the navigation and the zooming. This multiple-stage can thereby either be carried out as second pressure level or a function depending from the duration of the pressure influence.

An extremely user-friendly and self-explanatory operation is created this way for the thin client 2, which additionally permits a single-handed operation of the thin client, based on the ergonomically chosen arrangement of the control block 6 at the location of the buckling 34 in the frame 36.

I claim:

1. A portable communication device comprising a display and a control block, where different operational modes presettable by a user and/or preset self-explanatory based on the switching, are provided, whereby a specific allocation of the control block is defined for each operational mode and the allocation of the control block appurtenant to the current operational mode is activated and an otherwise keyless control and navigation through the different operational modes of the device is provided.

2. The portable communication device according to claim 1, wherein the control block comprises a swash-plate and a number of keys which surround the swash plate satellite-like.

3. The portable communication device according to claim 1 wherein the display comprises a rectangular design and further comprises a surrounding frame where the control block is integrated.

4. The portable communication device according to claim 3 wherein the control block referring to the display arranged in a horizontal position at the upper right part of the frame is arranged at an ergonomically designed buckling of the frame.

5. The portable communication device according to claim 1 wherein the display is designed rectangular and operable over the surface and the control block is realized shown on the display virtually.

6. The portable communication device according to claim 5 wherein a preset arrangement of the control block, dependant from an operational mode, is provided, preferably down to the right based on the display in a horizontal position.

7. The portable communication device according to claim 2 wherein the swash-plate is surrounded by four equidistantly arranged key elements based on the center of the swash-plate.

8. The portable communication device according to claim 7 wherein the key elements are arranged in the directions NW, NE, SE and SW.

9. The portable communication device according to claim 2, wherein the allocation of the swash-plate and the key elements follow the orientation of the display.

10. The portable communication device according to claim 9 further comprising means for the detection of the orientation of the display and an allocation each, in case of a display in horizontal and in case of the display in vertical position is provided according to the detected orientation.

11. The portable communication device according to claim 2 wherein the means are allocated to the swash-plate and the key elements which detect an intensity of the operating pressure and/or a duration of application and cause a respective modification of a function corresponding to the allocation to be controlled.
